(19) United States
(12) Patent Application Publication
(10) Pub. No.: US 2023/0015321 A1
(43) Pub. Date: Jan. 19, 2023

(54) SYSTEM AND METHOD FOR GENERATING A RESPONSE TO A USER QUERY

(71) Applicant: Flipkart Internet Private Limited, Bengaluru (IN)

(72) Inventor: Omprakash SONIE, Pune (IN)

(73) Assignee: Flipkart Internet Private Limited, Bengaluru (IN)

(21) Appl. No.: 17/860,709

(22) Filed: Jul. 8, 2022

(30) Foreign Application Priority Data
Jul. 9, 2021 (IN) 202141030950

(51) Int. Cl. G10L 15/22; G10L 15/30; G10L 15/06

(52) U.S. Cl. CPC G10L 15/22; G10L 15/30; G10L 15/063

(57) ABSTRACT

A system and method for generating a response to a user query. The method encompasses receiving, at a transceiver unit [102], the user query. The method thereafter leads to identifying, by an encoder unit [104], a user context associated with the user query based on one or more pre-stored datasets. Further the method encompasses predicting, by a prediction unit [106], one or more parameters corresponding the user query based on at least one of one or more offline-policies and one or more online-policies. The method thereafter comprises generating, by a decoder unit [108], the response to the user query based at least on the user context associated with the user query and the one or more parameters corresponding to the user query.

### TECHNICAL FIELD

The present invention generally relates to automatic response generation and more particularly to systems and methods for generating a response to a user query using reinforcement learning techniques.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With an immense growth in technologies such as including but not limited to speech recognition, voice assistant, query understanding and the like, facilities provided to users via various digital platforms also enhanced to a great extent and as a result the number of users on such digital platforms are increasing at a very rapid rate. The digital platforms provide the users a number of facilities such as including but not limited to facilities for communicating over various social media platforms, digitally selling and/or purchasing products over various e-commerce platforms, preforming digital transaction over various digital payment platforms and the like. In order to provide the digital facilities efficiently and effectively, customer care support of the respective digital platforms plays an important role in solving various user queries. Further, with the increase in number of the users on the digital platforms on continuous basis and/or on during a sale event associated with the digital platforms, there requires a number of human agents/customer care support agents for solving user queries of such increasing users. Therefore, now a days solving the user queries efficiently and effectively is becoming a challenging tasks for the digital platforms. Also, due to increase in the user/customer queries it is difficult for the digital platforms to deal with each user query in real time.

In order to overcome such limitations many solutions have been developed over a period of time. Some known arts provides a solution to automatically answer the user queries based on a previous chat data associated with similar user queries. Also, some other known solutions generates an automatic response to the user queries based on a current context and/or current input. These currently known conversational solutions such as chatbots take into account only current input, context from current chat and/or past history to respond to the user queries which limits the ability of said known conversational solutions to respond smartly to the user queries. Also, the exiting solutions have looked at very selective metrics and tried to improve them. Generally, the responses to the user queries generated by the currently known solutions are dull, general and/or repetitive. The currently known solutions while generating the response(s) to the user queries fail to consider aspects which a human agent would have taken and responded to the user queries smartly.

Therefore, there is a requirement to provide a solution which can help at least in improving interaction of users with conversational system(s)/chatbot(s), resolving more user queries in an efficient manner by providing a satisfactory response to such user queries, reducing dropping of user queries by users and reducing human agent interaction. Hence, there is a need in the art to provide a solution to efficiently and effectively generate a response to one or more user queries.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for efficiently and effectively generating an automatic response to a user query. Also, an object of the present invention is to predict an intention and/or a current state of a user based on a user input and/or a user context. Further, an object of the present invention is to predict response(s) of user(s) provided to a conversational system's/chatbot's response. Another object of the present invention is to generate a response to user queries by taking into account various aspects such as including but not limited to parameters which a human agent would have considered to respond to the user queries smartly, a current state user(s) and one or more previous interactions with the user(s).

Furthermore, in order to achieve the aforementioned objectives, the present invention provides a method and system for generating a response to a user query based on a prediction of one or more parameters corresponding the user query using at least one reinforcement learning technique.

A first aspect of the present invention relates to the method for generating a response to a user query. The method encompasses receiving, at a transceiver unit, the user query. The method thereafter leads to identifying, by an encoder unit, a user context associated with the user query based on one or more pre-stored datasets. Also, in an implementation the method encompasses predicting, by a prediction unit, a current state of the user based on the identified user context associated with the user query and/or the user query. Further the method encompasses predicting, by a prediction unit, one or more parameters corresponding the user query based on at least one of one or more offline-policies and one or more online-policies. The method thereafter comprises generating, by a decoder unit, the response to the user query based at least on the user context associated with the user query and the one or more parameters corresponding to the user query. Also, in an implementation the response generated for the user query is further based on the predicted current state of the user.

Another aspect of the present invention relates to a system for generating a response to a user query. The system comprises a transceiver unit, configured to receive, the user query. The system further comprises an encoder unit, configured to identify, a user context associated with the user query based on one or more pre-stored datasets. Also, the system comprises a prediction unit, configured to predict, a current state of the user based on the identified user context associated with the user query and/or the user query. The prediction unit is also configured to predict, one or more parameters corresponding the user query based on at least one of one or more offline-policies and one or more online-policies. The system further comprises a decoder unit, configured to generate, the response to the user query based at least on the user context associated with the user query and the one or more parameters corresponding to the user query. Also, in an implementation the response generated for the user query is further based on the predicted current state of the user.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings.

Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for generating a response to a user query, in accordance with exemplary embodiments of the present invention.

FIG. 2 illustrates an exemplary method flow diagram [200], for generating a response to a user query, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, a Graphics Processing Unit any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, a transceiver unit, a prediction unit, an encoder unit, a decoder unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, existing technologies relating to automatic response generation have many limitations and in order to overcome at least some of the limitations of the prior known solutions, the present disclosure provides a solution for generating a response to a user query. More particularly, to generate the response to the user query the present invention encompasses determining a user context associated with the user query. For instance, a context from a current chat and a past chat history is identified as a user context for a user query. Also, the present invention comprises learning online and/or offline policies to predict parameter(s) such as including but not limited to at least one of an anticipated future interaction, an anticipated incorrect action, an anticipated current satisfaction score associated with the user query, an anticipated satisfaction score associated with a new user query, an anticipated satisfaction score associated with a termination of the user query and an anticipated satisfaction score associated with a transfer of the user query etc. Furthermore, the online and/or offline policies are learned based on reinforcement learning technique(s). Also, the offline-policies comprises information indicative of a probability of one or more actions for one or more past user queries and the online-policies comprises information indicative of a probability of one or more actions for the current user query. Further, once the parameter(s) are predicted, the present invention encompasses generating the response to the user query based on the user context associated with the user query and the generated parameters for said user query. Furthermore, the present invention also encompasses using the response generated for the user query to further update the online and/or offline policies and to generate response to one or more new user queries based on the updated online and/or offline policies. Also, in an implementation, the present invention encompasses using response(s) provided by the users to the generated response to the one or more new user queries for learning policies against predictions made based on various policies.

Furthermore, based on the implementation of the features of the present invention, in order to further determine a reason of receipt of a user request for transferring a call/user query to a human agent, after transferring the call/user query to the human agent a response provided by the human agent to such transferred call/user query is analyzed to further update the online and/or offline policies. Thereafter, based on the online and/or offline policies that are updated basis the analysis of the response provided by the human agent to the transferred call/user query, it is determined that how efficiently the call/user query was analyzed prior to transferring to the human agent for generating the response to said call/user query, has the call/user query been understood properly to generate the response for said user query, if any action is performed to respond to the call/user query in an efficient manner to satisfy the user or it was beyond the capabilities to generate the response to the user query, and/or it was some issue at a digital platform level for which the human agent could have taken follow up action or may not have taken any action, etc. The reason of the receipt of the user request for transferring the call/user query to the human agent is determined to efficiently and effectively generate responses to future user queries and to eliminate/reduce requirement of transferring of calls/user queries to the human agent. Therefore, based on the implementation of the features of the present invention, user queries are resolved in an efficient manner by providing a satisfactory response to such user queries and thereby leading to a reduction in dropping of user queries by users.

Hereinafter, exemplary embodiments of the present disclosure will be described in detail with reference to the accompanying drawings so that those skilled in the art can easily carry out the present disclosure.

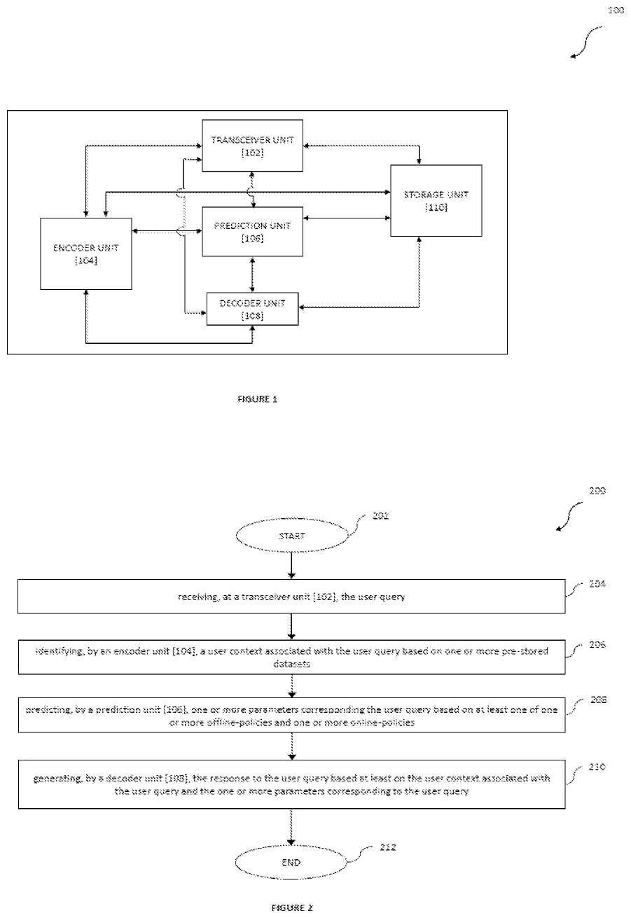

Referring to FIG. 1, an exemplary block diagram of a system [100] for generating a response to a user query is shown. The system [100] comprises at least one transceiver unit [102], at least one encoder unit [104], at least one prediction unit [106], at least one decoder unit [108] and at least one storage unit [110]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be configured at, at least one of a server device level (such as the server of the digital platform) and a device/client level, to implement the features of the present invention.

The system [100] is configured to generate the response to the user query, with the help of the interconnection between the components/units of the system [100].

The transceiver unit [102] of the system [100] is configured to receive, the user query from a user device of a user. More particularly, a communication link between the system [100] and the user device is established via the transceiver unit [102] and once the communication link between the system [100] and the user device is established, the transceiver unit [102] is configured to receive from the user device, the user query initiated by the user. The communication link between the system [100] and the user device may be a wired or wireless connection, via one or more networks, as may be known to persons skilled in the art. The user query may be any query related to one or more services provided by a digital platform. In an example a digital platform may be an e-commerce platform and a user query in the given example may be a query initiated by a user to confirm details of delivery of a product ordered by the user via said e-commerce platform.

The transceiver unit [102] is connected to the encoder unit [104]. Once the user query is received at the transceiver unit [102], the transceiver unit [102] is configured to transmit the user query to the encoder unit [104]. The encoder unit [104] is configured to identify, a user context associated with the user query based on one or more pre-stored datasets. In an implementation the user context is a traditional encoder context identified based on one or more known techniques of determining a context of a user query. The one or more pre-stored datasets are one or more historic datasets comprising of a past data associated with one or more queries posted on the digital platform by a same user who has posted the user query on the digital platform and/or one or more other users of the digital platform. Each pre-stored dataset from the one or more pre-stored datasets comprises a data associated with one or more past chats associated with one or more past user queries and/or a data associated one or more past calls associated with the one or more past user queries. This historic data may be past data of the same user who has posted the user query on the digital platform or the one or more other users of the digital platform. More particularly, the encoder unit [104] is configured to identify, the user context associated with the user query based on a data associated with one or more past chats associated with one or more past user queries similar to the user query and/or a data associated with one or more past calls associated with the one or more past user queries similar to the user query. To accomplish this, a similarity is determined between the user query received in the previous step and the one or more past user queries and/or the one or more past calls, based on techniques known to a person skilled in the art. For example, if a user query is “why my order ABC is delayed” for an order ABC placed via an e-commerce platform, in the given example, the encoder unit [104] is configured to identify, a user context associated with the user query “why my order ABC is delayed” based on a data associated with one or more past chats and/or one or more past calls associated with one or more past user queries initiated for delayed order delivery.

The transceiver unit [102] and the encoder unit [104] are connected to the prediction unit [106]. The transceiver unit [102] is also configured to transmit the user query and the identified user context associated with the user query to the prediction unit [106]. The prediction unit [106] is configured to predict, a current state of the user based on the identified user context associated with the user query and/or the user query. Also, the prediction unit [106] is configured to predict, one or more parameters corresponding the user query based on at least one of one or more offline-policies and one or more online-policies. Further, the prediction unit [106] is also configured to learn the one or more offline-policies and the one or more online-policies based on at least one reinforcement learning technique. Each policy from the one or more offline-policies comprises an information indicative of a probability of one or more actions for the one or more past user queries. The one or more actions for the one or more past user queries are one or more actions that may be taken to generate a response to the one or more past user queries. For example, if a past user query relates to confirmation of status of an order purchased via an e-commerce platform, an offline policy in the given example may comprise an information indicative of a probability of one or more actions that may be taken to generate a response to said past user query, such as the offline policy may comprise an information indicative of a probability of an identification of the status of said order if only a single order is placed or the offline policy may comprise an information indicative of a probability of an identification of the order for which said past user query was initiated etc.

Further, in an implementation, each policy from the one or more offline-policies is learned based on the data associated with the one or more past chats associated with the one or more past user queries and/or the data associated with the one or more past calls associated with the one or more past user queries, using the at least one reinforcement learning technique. In an example each policy from the one or more offline-policies is learned based on an information associated with at least one of a state, action and reward identified from previous history of chats/calls associated with the one or more past user queries and their annotations, wherein each policy from the one or more offline-policies is learned using the at least one reinforcement learning technique. Also, in an example said state may be a background of a chat/call associated with the one or more past user queries. Also, in an example said action may be a response to the one or more past user queries identified from the previous history of chats/calls associated with said one or more past user queries. Also, in an example said reward may be a data element associated with an action identified from the previous history of chats/calls associated with the one or more past user queries, wherein said data element may indicate whether the action is suitable or unsuitable to respond a past user query. Also, in an implementation, said action identified from the previous history of chats/calls associated with the one or more past user queries may include but not limited to at least one of a response predicted for the one or more past user queries and a user response to the response predicted for the one or more past user queries.

Also, each policy from the one or more online-policies comprises an information indicative of a probability of one or more actions for the user query, wherein the one or more actions for the user query are one or more actions that may be taken to generate the response to said user query. For example, if a current user query relates to payment confirmation of an order purchased via an e-commerce platform, an online policy in the given example may comprise an information indicative of a probability of one or more actions that may be taken to generate a response to said current user query, such as the online policy may comprise an information indicative of a probability of an identification of the status of the payment made if only a single order is placed and/or the online policy may comprise an information indicative of a probability of identification of an order for which said current query is initiated etc.

Furthermore, in an implementation, each policy from the one or more online-policies is learned based on a data associated with the user query (such as a data related to a current chat/call initiated for the user query), using the at least one reinforcement learning technique. In an example each policy from the one or more online-policies is learned based on an information associated with at least one of a state, action and reward identified from a current information associated with chats/calls associated with the user query for which the response is to be generated, wherein each policy from the one or more online-policies is learned using the at least one reinforcement learning technique. Also, in an example said state may be a background of a chat/call associated with the user query for which the response is to be generated. Also, in an example said action may be a response that may be generated for the user query. Also, in an example said reward may be a data element associated with an action that may be generated for the user query, wherein said data element may indicate whether the action is suitable or unsuitable to respond the user query. Also, in an implementation, said action that may be generated for the user query may include but not limited to at least one of a response that may be predicted for the user query and a user response to the response that may be predicted for the user query.

Furthermore, to predict the one or more parameters corresponding the user query, the prediction unit [106] is firstly configured to determine, a probability of the one or more actions for the user query based on at least one of the one or more offline-policies and the one or more online-policies. The one or more actions for the user query are the one or more actions that may be taken to generate the response to said user query. Once the probability of the one or more actions for the user query based on at least one of the one or more offline-policies and the one or more online-policies is determined, the prediction unit [106] is configured to predict, the one or more parameters corresponding the user query based on said probability of the one or more actions determined based on at least one of the one or more offline-policies and the one or more online-policies. Furthermore, each predicted parameter from the one or more predicted parameters indicates one of an anticipated future interaction, an anticipated incorrect action, an anticipated current satisfaction score associated with the user query, an anticipated satisfaction score associated with the new user query, an anticipated satisfaction score associated with a termination of the user query and an anticipated satisfaction score associated with a transfer of the user query etc. In an example, if a user query is to confirm status of a return request of an order placed via an e-commerce platform, the prediction unit [106] in such instance is firstly configured to determine a probability of an action (such as a confirmation indicating the return request is accepted), for said user query based on at least one of an offline-policy and an online-policy, wherein the offline-policy comprises an information indicative of a probability of a confirmation indicating a return request is accepted for one or more past user queries similar to the user query and the online policy comprises an information indicative of a probability of a confirmation indicating the return request is accepted for the current user query. Further, once the probability of the action i.e. the confirmation indicating the return request is accepted, is determined based on at least one of the offline-policy and the online-policy, the prediction unit [106] is configured to predict, one or more parameters corresponding the user query based on the probability of said action determined based on at least one of the offline-policy and the online-policy.

Furthermore, in an event each predicted parameter from the one or more predicted parameters indicates one of an anticipated future interaction such as a next user query to confirm a pick up status corresponding to the order for which the return request is accepted, an anticipated incorrect action such as an unavailability of a date on which the return request is accepted, an anticipated current satisfaction score associated with the user query such as a current score indicating user's satisfaction with respect to the confirmation indicating the return request is accepted in response to the user query, an anticipated satisfaction score associated with the new user query such as a score indicating user's satisfaction with respect to the pick-up status corresponding to the order for which the return request is accepted, an anticipated satisfaction score associated with a termination of the user query such as a score indicating user's satisfaction while terminating the initiated user query and an anticipated satisfaction score associated with a transfer of the user query such as a score indicating user's satisfaction while initiating a request to transfer the user query to a human agent etc.

Further, the transceiver unit [102], the encoder unit [104] and the prediction unit [106] are connected to the decoder unit [108]. The decoder unit [108] is configured to generate, the response to the user query based at least on the user context associated with the user query and the one or more parameters corresponding to the user query. More particularly, once the user context associated with the user query is identified and the one or more parameters corresponding to the user query are predicted, the decoder unit [108] is configured to generate, the response to the user query based at least on a combination of the user context associated with the user query and the one or more predicted parameters corresponding to the user query. Also, in an implementation, the response generated for the user query is further based on the predicted current state of the user. More specifically, in the given implementation the decoder unit [108] is configured to generate, the response to the user query based on the user context associated with the user query, the current state of the user and the one or more predicted parameters corresponding to the user query.

Also, once the response to the user query is generated by the decoder unit [108], the prediction unit [106] is configured to receive, said response to the user query from the decoder unit [108]. Further, prediction unit [106] is configured to update, at least one of the one or more offline-policies and the one or more online-policies based on the response to the user query. The prediction unit [106] is configured to update, at least one of the one or more offline-policies and the one or more online-policies by learning one or more policies based on the response generated for the user query. Also, in an implementation the prediction unit [106] is configured to update, at least one of the one or more offline-policies and the one or more online-policies by learning one or more policies against one or more predictions made to predict the one or more parameters corresponding the user query, based on one or more response provided by the user to the generated response to the user query. Furthermore, in an implementation the generated response to the user query may be transferring of said user query to a human agent basis a receipt of a user request for transferring said user query to the human agent. In the given implementation, the prediction unit [106] is also configured to update, at least one of the one or more offline-policies and the one or more online-policies by learning one or more policies based on a response provided by the human agent to such transferred user query. Thereafter, based on the online and/or offline policies that are updated basis the response provided by the human agent to the transferred user query, prediction unit [106] is configured to determine: how efficiently the user query was analyzed prior to transferring to the human agent for generating the response to said user query; has the user query been understood properly to generate the response for said user query; if any action is performed to respond to the user query in an efficient manner to satisfy the user or it was beyond the capabilities to generate the response to the user query; and/or it was some issue at the digital platform level for which the human agent could have taken follow up action or may not have taken any action, etc. Therefore, based on the implementation of the features of the present invention, a reason of receipt of the user request for transferring the user query to the human agent is determined to efficiently and effectively generate responses to future user queries and to eliminate/reduce requirement of transferring of user queries to the human agent.

Further considering an example, if there is an ‘End of Season Sale’ on an e-commerce platform, all chats during such sale event may be weakly associated with the sale event. Once a chat during the sale event is over it may be provided to the prediction unit [104] and modified to associate or not with the sale event. Further, the prediction unit [106] is configured to update at least one of the one or more offline-policies and the one or more online-policies based on the received chat data, wherein the updated one or more offline/online-policies help in reacting to a recent rush of calls/chats after the sale event and to similar types of calls/chats to answer better.

Furthermore, in an implementation, the transceiver unit [102] is further configured to receive a new user query. Thereafter, the encoder unit [104] is configured to identify the user context associated with the new user query based on the one or more pre-stored datasets. In an implementation the user context associated with the new user query is identified in a similar manner as that of the identification of the user context associated with the user query by the encoder unit [104]. Further, the prediction unit [106] is configured to predict the one or more new parameters corresponding the new user query based on at least one of the one or more updated offline-policies and the one or more updated online-policies. In an implementation the one or more new parameters corresponding the new user query are predicted in a similar manner as that of prediction of the one or more parameters corresponding the user query by the prediction unit [106]. Also, each new predicted parameter from the one or more new predicted parameters indicates one of the anticipated future interaction, the anticipated incorrect action, the anticipated current satisfaction score associated with the new user query, an anticipated satisfaction score associated with a next user query, an anticipated satisfaction score associated with a termination of the new user query and an anticipated satisfaction score associated with a transfer of the new user query etc. Once the user context associated with the new user query is identified and the one or more new parameters corresponding the new user query are predicted, the decoder unit [108] is then configured to generate, a response to the new user query based at least on the user context associated with the new user query and the one or more parameters corresponding to the new user query.

Further, a few examples indicating a response generated for user queries are provided as below in use case 1 and in use case 2:

Use Case 1: The use case 1, as provided in below in Table 1 indicates an example where multi-turn user queries related to status of delivery of orders are initiated by a user. Also, Table 1 depicts that the user is in ok mood and is satisfied with a response generated based on the implementation of the features of the present invention. In an implementation, the generated response may be provided to the user via a Chatbot.

TABLE 1

| | Response | |
|---|---|---|
| User Query | Generated | Predicted Parameters |
| I want to | | Predicted Parameters-chat |
| know | | response good (Current |
| status of | | satisfaction score above ‘A’, |
| delivery1 -> | | wherein A indicates a threshold |
| | <- What is the | satisfaction score to predict a chat |
| | order number | response based on a current |
| | <- Provides | satisfaction score associated with |
| | order details | a user) |
| | | Predicted Parameters-user |
| | | satisfied end of call (Satisfaction |
| | | score associated with a |
| | | termination of the user query is |
| | | above ‘B’, wherein B indicates a |
| | | threshold satisfaction score to |
| | | predict current satisfaction score |
| | | associated with a user till end of |
| | | the call), |
| | | wherein the parameters are |
| | | predicted based on learning of at |
| | | least one of an offline and an |
| | | online policy-user in ok mood |
| | | <- if there are more than one order |
| | <- Would you | Predicted Parameters-next turn |
| | like to know | for status enquiry (Future |
| | anything else? | interaction) |
| Yes, what is | | Predicted Parameters-chat |
| the status of | | response good, and |
| order 2 -> | | Predicted Parameters-user |
| | <- What is the | satisfied end of call, |
| | order number | wherein the parameters are |
| | <- Provides | predicted based on learning of at |
| | order details | least one of an offline and an |
| | | online policy-user in ok mood |
| | <- Anything | |
| | else you would | |
| | like to know? | |
| No thanks -> | | |

Use Case 2: The use case 2, as provided in below in Table 2 indicates an example where multi-turn user queries related to status of delayed delivery of orders are initiated by a user. Also, Table 2 depicts that the user is frustrated and is satisfied with a response generated based on the implementation of the features of the present invention. In an implementation, the generated response may be provided to the user via a Chatbot.

TABLE 2

| | Response | |
|---|---|---|
| User Query | Generated | Predicted Parameters |
| I am really | | Predicted Parameters-Chat |
| frustrated, | | response good |
| my delivery1 | | Context-Delivery is delayed |
| is delayed -> | | beyond normal |
| | <- What is the | wherein the parameters are |
| | order number | predicted based on learning of |
| | <- Provides | at least one of an offline and an |
| | order details | online policy-user is frustrated |
| | | Predicted Parameters-Next |
| | | turn (future interaction) for: |
| | | 1. Where is it |
| | | 2. When can delivery be |
| | | expedited |
| | | 3. User may end call/chat |
| | | 4. User may ask to |
| | | transfer to call/chat to |
| | | human agent |
| | <- Provide options | |
| | i, ii, iii and iv | |
| | corresponding to | |
| | the predicted next | |
| | turn (future | |
| | interaction) | |
| | parameters | |
| | 1, 2, 3 and 4 | |
| User provides | | |
| response either | | |
| i, ii, iii or iv -> | | |
| | -> pass response | |
| | to prediction | |
| | unit [106] | |
| | if it is i, ii, iv | |
| | | -> If response is iii, update at |
| | | least one of the offline and the |
| | | online policy based on |
| | | learning-ended call |
| | | -> if response is iv, transfer |
| | | call to the human agent |
| | | <- if response is i |
| | <- for 1: provide | |
| | where details | |
| | | <- if response is ii |
| | <- for 2: provide | |
| | what can be done | |
| | | Predicted Parameters-Next |
| | | turn for 1 and 2, and |
| | | Predicted Parameters-User |
| | | may end the call/chat or may |
| | | ask to transfer the call/chat to |
| | | the human agent, |
| | | wherein, at least one of the |
| | | offline and the online policy |
| | | updated based on learning- |
| | | 1. How much delay |
| | | frustrated the user |
| | | 2. The user still continue |
| | | to have the delivery |

Referring to FIG. 2 an exemplary method flow diagram [200], for generating a response to a user query, in accordance with exemplary embodiments of the present invention is shown. In an implementation the method is performed by the system [100]. Further, in an implementation, the system [100] may be configured at, at least one of a server device level and a client/device level, to implement the features of the present invention. Also, as shown in FIG. 2, the method starts at step [202]. The disclosure encompasses that the method begins when a user of a digital platform posts a query on the digital platform via a user device.

At step [204] the method comprises receiving, at a transceiver unit [102], the user query from a user device of a user. The user query may be any query related to one or more services provided by the digital platform. In an example a digital platform may be an e-commerce platform and a user query in the given example may be a query initiated by a user to confirm details of refund of a product returned by the user via said e-commerce platform. The disclosure encompasses that the user query is received at the transceiver unit [102] in real-time from the user device, i.e. without any delay. Further, in order to receive the user query at the transceiver unit [102], a connection is established between the user device and the system [100]. In an event, a connection has already been established between the system [100] and the user device, the same is used for receiving the user query. Once the user query is received at the transceiver unit [102], the method encompasses transmitting the user query to an encoder unit [104] from the transceiver unit [102]. Also, the method encompasses transmitting the user query to a prediction unit [106] from the transceiver unit [102].

Next at step [206] the method comprises identifying, by the encoder unit [104], a user context associated with the user query based on one or more pre-stored datasets. In an implementation the user context is a traditional encoder context identified based on one or more known techniques of determining a context of a user query. The one or more pre-stored datasets are one or more historic datasets comprising of a past data associated with one or more queries posted on the digital platform by a same user who has posted the user query on the digital platform and/or one or more other users of the digital platform. Each pre-stored dataset from the one or more pre-stored datasets comprises a data associated with one or more past chats associated with one or more past user queries and/or a data associated one or more past calls associated with the one or more past user queries. More particularly, the method encompasses identifying by the encoder unit [104], the user context associated with the user query based on a data associated with one or more past chats associated with one or more past user queries similar to the user query and/or a data associated with one or more past calls associated with the one or more past user queries similar to the user query. To accomplish this, the method encompasses determining a similarity between the user query received in the previous step with the one or more past user queries and/or the one or more past calls, based on techniques known to a person skilled in the art. For example, if a user query is “why the refund of returned product ABC is delayed” for an order ABC returned via an e-commerce platform, in the given example, the method encompasses identifying by the encoder unit [104], a user context associated with the user query “why the refund of returned product ABC is delayed” based on a data associated with one or more past chats and/or one or more past calls associated with one or more past user queries initiated for delayed refund of returned product(s).

Also, the method comprises predicting, by the prediction unit [106], a current state of the user based on the identified user context associated with the user query and/or the user query. Further, at step [208] the method also comprises predicting, by the prediction unit [106], one or more parameters corresponding the user query based on at least one of one or more offline-policies and one or more online-policies. Also, the method encompasses learning by the prediction unit [106], the one or more offline-policies and the one or more online-policies based on at least one reinforcement learning technique. Each policy from the one or more offline-policies comprises an information indicative of a probability of one or more actions for the one or more past user queries. The one or more actions for the one or more past user queries are one or more actions that may be taken/considered to generate a response to the one or more past user queries. For example, if a past user query relates to confirmation of status of an order returned via an e-commerce platform, an offline policy in the given example may comprise an information indicative of a probability of one or more actions that may be taken/considered to generate a response to said past user query, for instance the offline policy may comprise an information indicative of a probability of an action such as an identification of the status of said order if only a single order is returned or the offline policy may comprise an information indicative of a probability of an action such as an identification of the returned order for which said past user query was initiated etc.

Further, in an implementation, each policy from the one or more offline-policies is learned using one or more reinforcement learning techniques, based on the data associated with the one or more past chats associated with the one or more past user queries and/or the data associated with the one or more past calls associated with the one or more past user queries. In an implementation, each policy from the one or more offline-policies is learned based on an information associated with at least one of a state, action and reward identified from previous history of chats/calls associated with the one or more past user queries and their annotations, wherein each policy from the one or more offline-policies is learned using the at least one reinforcement learning technique. Also, in an example said state may be a background of a chat/call associated with the one or more past user queries. Also, in an example said action may be a response to the one or more past user queries identified from the previous history of chats/calls associated with said one or more past user queries. Also, in an example said reward may be a data element associated with an action identified from the previous history of chats/calls associated with the one or more past user queries, wherein said data element may indicate whether the action is suitable or unsuitable to respond a past user query. Also, in an implementation, said action identified from the previous history of chats/calls associated with the one or more past user queries may include but not limited to at least one of a response predicted for the one or more past user queries and a user response to the response predicted for the one or more past user queries.

Also, each policy from the one or more online-policies comprises an information indicative of a probability of one or more actions for the user query (i.e. the current query initiated by the user), wherein the one or more actions for the user query are one or more actions that may be taken/considered to generate the response to said user query. For example, if a current user query relates to cancelation of an order purchased via an e-commerce platform, an online policy in the given example may comprise an information indicative of a probability of one or more actions that may be taken to generate a response to said current user query, such as the online policy may comprise an information indicative of a probability of an identification of a status of a payment refund if the payment was made initially and only a single order is canceled and/or the online policy may comprise an information indicative of a probability of identification of a canceled order for which said current query is initiated etc.

Furthermore, in an implementation, each policy from the one or more online-policies is learned based on a data associated with the user query (such as a data related to a current chat/call initiated for the user query), using the at least one reinforcement learning technique. In an implementation each policy from the one or more online-policies is learned based on an information associated with at least one of a state, action and reward identified from a current information associated with chats/calls associated with the user query for which the response is to be generated, wherein each policy from the one or more online-policies is learned using the at least one reinforcement learning technique. Also, in an example said state may be a background of a chat/call associated with the user query for which the response is to be generated. Also, in an example said action may be a response that may be generated for the user query. Also, in an example said reward may be a data element associated with an action that may be generated for the user query, wherein said data element may indicate whether the action is suitable or unsuitable to respond the user query. Also, in an implementation, said action that may be generated for the user query may include but not limited to at least one of a response that may be predicted for the user query and a user response to the response that may be predicted for the user query.

Furthermore, the process of predicting, by the prediction unit [106], the one or more parameters corresponding the user query firstly comprises determining, by the prediction unit [106], a probability of one or more actions for the user query based on at least one of the one or more offline-policies and the one or more online-policies. The one or more actions for the user query are the one or more actions that may be taken to generate the response to said user query. Once the probability of the one or more actions for the user query based on at least one of the one or more offline-policies and the one or more online-policies is determined, said process leads to predicting, by the prediction unit [106], the one or more parameters corresponding to the user query based on the probability of the one or more actions determined based on at least one of the one or more offline-policies and the one or more online-policies. Furthermore, each predicted parameter from the one or more predicted parameters indicates one of an anticipated future interaction, an anticipated incorrect action, an anticipated current satisfaction score associated with the user query, an anticipated satisfaction score associated with the new user query, an anticipated satisfaction score associated with a termination of the user query and an anticipated satisfaction score associated with a transfer of the user query etc.

In an example, if a user query is to confirm status of a return request of an order placed via an e-commerce platform, the method in such instance firstly encompasses determining by prediction unit [106], a probability of an action (such as a confirmation indicating the return request is accepted), for said user query based on at least one of an offline-policy and an online-policy, wherein the offline-policy comprises an information indicative of a probability of a confirmation indicating a return request is accepted for one or more past user queries similar to the user query and the online policy comprises an information indicative of a probability of a confirmation indicating the return request is accepted for the current user query. Further, once the probability of the action i.e. the confirmation indicating the return request is accepted, is determined based on at least one of the offline-policy and the online-policy, the method encompasses predicting by the prediction unit [106], one or more parameters corresponding the user query based on the probability of said action determined based on at least one of the offline-policy and the online-policy. Furthermore, in an event each predicted parameter from the one or more predicted parameters indicates one of an anticipated future interaction such as a next user query to cancel the return request corresponding to the order for which the return request is accepted, an anticipated incorrect action such as an unavailability of cancelation of the return request that is accepted, an anticipated current satisfaction score associated with the user query such as a current score indicating user's satisfaction or response with respect to the confirmation indicating the return request is accepted in response to the user query, an anticipated satisfaction score associated with the new user query such as a score indicating user's satisfaction with respect to the user query of cancelation of the return request corresponding to the order for which the return request is accepted, an anticipated satisfaction score associated with a termination of the user query such as a score indicating user's satisfaction while terminating the initiated user query and an anticipated satisfaction score associated with a transfer of the user query such as a score indicating user's satisfaction while initiating a request to transfer the user query to a human agent.

The present disclosure encompasses that the method steps [206] and [208] are executed simultaneously. Also, the user context identified at the step [206] and the one or more parameters corresponding the user query predicted at the step [208] are provided simultaneously to a decoder unit [108] for further processing at step [210].

Next, at step [210] the method comprises generating, by the decoder unit [108], the response to the user query based at least on the user context associated with the user query and the one or more parameters corresponding to the user query. More particularly, once the user context associated with the user query is identified and the one or more parameters corresponding to the user query are predicted, the method encompasses generating by the decoder unit [108], the response to the user query based at least on a combination of the user context associated with the user query and the one or more predicted parameters corresponding to the user query. For example, if a user query is “I am annoyed, refund for my returned order is not initiated”, a user context for said user query may be “refund is delayed beyond normal” and a predicted parameters corresponding to the user query may be “user may ask to transfer the call/chat to human agent”, in the given instance the method encompasses generating, by the decoder unit [108], the response to the user query i.e. “I am annoyed, refund for my returned order is not initiated” based on a combination of the user context i.e. “refund is delayed beyond normal” and the predicted parameter i.e. “user may ask to transfer the call/chat to human agent”. For example, the generated response in the given scenario may be “providing the user a date of initiation of refund process”. Also, in an implementation, the response generated for the user query is further based on the predicted current state of the user. More specifically, in the given implementation the method comprises generating by the decoder unit [108], the response to the user query based on the user context associated with the user query, the current state of the user and the one or more predicted parameters corresponding to the user query.

Also, once the response to the user query is generated by the decoder unit [108], the method further comprises receiving, at the prediction unit [106], said generated response to the user query from the decoder unit [108]. The method thereafter leads to updating, by the prediction unit [106] at least one of the one or more offline-policies and the one or more online-policies based on the response to the user query. The method encompasses updating, by the prediction unit [106], at least one of the one or more offline-policies and the one or more online-policies by learning one or more policies based on the response generated for the user query. Also, in an implementation the method encompasses updating, by the prediction unit [106], at least one of the one or more offline-policies and the one or more online-policies by learning one or more policies against one or more predictions made to predict the one or more parameters corresponding the user query, based on one or more response provided by the user to the generated response to the user query. Furthermore, in an implementation the generated response to the user query may be transferring of said user query to a human agent basis a receipt of a user request for transferring said user query to the human agent. In the given implementation, the method encompasses updating by the prediction unit [106], at least one of the one or more offline-policies and the one or more online-policies by learning one or more policies based on a response provided by the human agent to such transferred user query. Thereafter, based on the online and/or offline policies that are updated basis the response provided by the human agent to the transferred user query, the method encompasses determining by the prediction unit [106]: how efficiently the user query was analyzed prior to transferring to the human agent for generating the response to said user query; has the user query been understood properly to generate the response for said user query; if any action is performed to respond to the user query in an efficient manner to satisfy the user or it was beyond the capabilities to generate the response to the user query; and/or it was some issue at the digital platform level for which the human agent could have taken follow up action or may not have taken any action, etc. Therefore, based on the implementation of the features of the present invention, a reason of receipt of the user request for transferring the user query to the human agent is determined to efficiently and effectively generate responses to future user queries and to eliminate/reduce requirement of transferring of user queries to the human agent.

Also, in an implementation the method further comprises receiving, at the transceiver unit [102], a new user query. The method thereafter leads to identifying, by the encoder unit [104], the user context associated with the new user query based on the one or more pre-stored datasets. In an implementation the user context associated with the new user query is identified in a similar manner as that of the identification of the user context associated with the user query by the encoder unit [104]. Further the method comprises predicting, by the prediction unit [106], one or more new parameters corresponding the new user query based on at least one of the one or more updated offline-policies and the one or more updated online-policies. In an implementation the one or more new parameters corresponding the new user query are predicted in a similar manner as that of prediction of the one or more parameters corresponding the user query by the prediction unit [106]. Also, each new predicted parameter from the one or more new predicted parameters indicates one of the anticipated future interaction, the anticipated incorrect action, the anticipated current satisfaction score associated with the new user query, an anticipated satisfaction score associated with a next user query, an anticipated satisfaction score associated with a termination of the new user query and an anticipated satisfaction score associated with a transfer of the new user query etc. Once the user context associated with the new user query is identified and the one or more new parameters corresponding the new user query are predicted, the method encompasses generating, by the decoder unit [108], a response to the new user query based at least on the user context associated with the new user query and the one or more parameters corresponding to the new user query.

After generating the response to the user query, the method terminates at step [212].

Further, a few examples indicating a response generated for user queries are provided as below in use case 3 and in use case 4:

Use Case 3: The use case 3, as provided in below in Table 3 indicates an example where a user query related to status of delivery of orders is initiated by a user. Also, Table 3 depicts that the user is angry and ends call/chat or asks to transfer the call/chat to human agent. In an implementation, the generated response may be provided to the user via a Chatbot.

TABLE 3

| | Response | |
|---|---|---|
| User Query | Generated | Predicted Parameters |
| I am really | | Predicted Parameters-Next turn |
| angry, my | | (future interaction) for: |
| delivery is | | 1. Where is it |
| delayed -> | | 2. When can delivery be |
| | | expedited |
| | | 3. User may end call/chat |
| | | 4. User may ask to transfer to |
| | | call/chat to human agent |
| | | wherein the parameters are |
| | | predicted based on learning of at |
| | | least one of an offline and an online |
| | | policy-user is angry. |
| | | Give higher probability to 3, 4 |
| | | <- suggest user to speak to the |
| | | human agent before he ends |
| | | call/chat or asks to transfer the |
| | | call/chat to the human agent. |
| | <- would | |
| | you like to | |
| | speak to | |
| | the human | |
| | agent? | |
| | | wherein, at least one of the offline |
| | | and the online policy updated based |
| | | on learning- |
| | | 1. How much delay made the |
| | | user angry |
| | | 2. The user still continue to |
| | | have the delivery |

Use Case 4: The use case 4, as provided in below in Table 4 indicates an example where a user query related to status of delayed delivery of orders is initiated by a user. Also, Table 4 depicts that the user is angry and wishes to cancel the order. In an implementation, the generated response may be provided to the user via a Chatbot.

TABLE 4

| | Response | |
|---|---|---|
| User Query | Generated | Predicted Parameters |
| I have been | | Predicted Parameters-Next turn |
| following | | (future interaction) for: |
| up for delayed | | 1. Where is it |
| delivery of the | | 2. When can delivery be |
| order placed -> | | expedited |
| | | 3. User may end call/chat |
| | | 4. User may ask to transfer to |
| | | call/chat to human agent |
| | | 5. User may cancel the order |
| | | placed |
| | | wherein the parameters are |
| | | predicted based on learning of at |
| | | least one of an offline and an online |
| | | policy-user is angry. |
| | | Give higher probability to 3, 4, 5 |
| | | <- suggest the user to speak to the |
| | | human agent before he ends |
| | | call/chat or asks to transfer |
| | | call/chat to the human agent |
| | <- would | |
| | you like to | |
| | speak to | |
| | the human | |
| | agent? | |
| | | wherein, at least one of the offline |
| | | and the online policy updated |
| | | based on learning- |
| | | 1. How much delay made the |
| | | user angry |
| | | 2. User cancels the order |

Thus, the present invention provides a novel solution for generating a response to a user query based on a user context associated with the user query and one or more parameters corresponding the user query, wherein the one or more parameters are predicted based on at least one of one or more offline-policies and one or more online-policies. Furthermore, the present invention provides a solution for generating a response to a user query based on at least one reinforcement learning technique by learning the one or more offline-policies and the one or more online-policies using the at least one reinforcement learning technique. The present invention provides a technical advancement of the known solutions by generating a more efficient and effective response to a user query based on learning of various online/offline-policies using reinforcement learning technique(s). Also, the present invention provides a technical effect by improving interaction of users with conversational system(s)/chatbot(s), resolving more user queries (for instance during a peak time such as a sales event at an e-commerce platform) in real time and in an efficient manner by providing a satisfactory response to such user queries, reducing dropping of user queries by users and reducing human agent interaction.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method for generating a response to a user query, the method comprising:
receiving, at a transceiver unit [102], the user query;
identifying, by an encoder unit [104], a user context associated with the user query based on one or more pre-stored datasets;
predicting, by a prediction unit [106], one or more parameters corresponding the user query based on at least one of one or more offline-policies and one or more online-policies; and
generating, by a decoder unit [108], the response to the user query based at least on the user context associated with the user query and the one or more parameters corresponding to the user query.

2. The method as claimed in claim 1, wherein each policy from the one or more offline-policies comprises an information indicative of a probability of one or more actions for one or more past user queries.

3. The method as claimed in claim 1, wherein each policy from the one or more online-policies comprises an information indicative of a probability of one or more actions for the user query.

4. The method as claimed in claim 1, the method further comprises learning the one or more offline-policies and the one or more online-policies based on at least one reinforcement learning technique.

5. The method as claimed in claim 4, wherein predicting, by the prediction unit [106], the one or more parameters corresponding the user query further comprises:
determining, by the prediction unit [106], a probability of the one or more actions for the user query based on at least one of the one or more offline-policies and the one or more online-policies, and
predicting, by the prediction unit [106], the one or more parameters corresponding the user query based on the determined probability of the one or more actions for the user query.

6. The method as claimed in claim 1, the method further comprises:
receiving, at the prediction unit [106], the response to the user query, and
updating, by the prediction unit [106] at least one of the one or more offline-policies and the one or more online-policies based on the response to the user query.

7. The method as claimed in claim 6, the method further comprises:
receiving, at the transceiver unit [102], a new user query,
identifying, by the encoder unit [104], the user context associated with the new user query based on the one or more pre-stored datasets,
predicting, by the prediction unit [106], one or more new parameters corresponding the new user query based on at least one of the one or more updated offline-policies and the one or more updated online-policies, and
generating, by the decoder unit [108], a response to the new user query based at least on the user context associated with the new user query and the one or more parameters corresponding to the new user query.

8. The method as claimed in claim 1, wherein each predicted parameter from the one or more predicted parameters indicates one of an anticipated future interaction, an anticipated incorrect action, an anticipated current satisfaction score associated with the user query, an anticipated satisfaction score associated with the new user query, an anticipated satisfaction score associated with a termination of the user query and an anticipated satisfaction score associated with a transfer of the user query.

9. A system for generating a response to a user query, the system comprising:
a transceiver unit [102], configured to receive, the user query;
an encoder unit [104], configured to identify, a user context associated with the user query based on one or more pre-stored datasets;
a prediction unit [106], configured to predict, one or more parameters corresponding the user query based on at least one of one or more offline-policies and one or more online-policies; and
a decoder unit [108], configured to generate, the response to the user query based at least on the user context associated with the user query and the one or more parameters corresponding to the user query.

10. The system as claimed in claim 9, wherein each policy from the one or more offline-policies comprises an information indicative of a probability of one or more actions for one or more past user queries.

11. The system as claimed in claim 9, wherein each policy from the one or more online-policies comprises an information indicative of a probability of one or more actions for the user query.

12. The system as claimed in claim 9, wherein the prediction unit [106] is further configured to learn the one or more offline-policies and the one or more online-policies based on at least one reinforcement learning technique.

13. The system as claimed in claim 9, wherein to predict the one or more parameters corresponding the user query the prediction unit [106] is further configured to:
determine, a probability of the one or more actions for the user query based on at least one of the one or more offline-policies and the one or more online-policies, and
predict, the one or more parameters corresponding the user query based on the determined probability of the one or more actions for the user query.

14. The system as claimed in claim 9, wherein the prediction unit [106] is further configured to:
receive, the response to the user query, and
update, at least one of the one or more offline-policies and the one or more online-policies based on the response to the user query.

15. The system as claimed in claim 9, wherein the transceiver unit [102] is further configured to receive a new user query.

16. The system as claimed in claim 15, wherein the encoder unit [104] is further configured to identify the user context associated with the new user query based on the one or more pre-stored datasets.

17. The system as claimed in claim 16, wherein the prediction unit [106] is further configured to predict the one or more new parameters corresponding the new user query based on at least one of the one or more updated offline-policies and the one or more updated online-policies.

18. The system as claimed in claim 17, wherein the decoder unit [108] is further configured to generate, a response to the new user query based at least on the user context associated with the new user query and the one or more parameters corresponding to the new user query.

19. The system as claimed in claim 9, wherein each predicted parameter from the one or more predicted parameters indicates one of an anticipated future interaction, an anticipated incorrect action, an anticipated current satisfaction score associated with the user query, an anticipated satisfaction score associated with the new user query, an anticipated satisfaction score associated with a termination of the user query and an anticipated satisfaction score associated with a transfer of the user query.
